(19) United States
(12) Patent Application Publication
(10) Pub. No.: US 2016/0257602 A1
(43) Pub. Date: Sep. 8, 2016

(54) USING SILICON TETRAFLOURIDE DURING POWDER-IN-TUBE (PIT) PROCESS

(71) Applicant: OFS Fitel, LLC, Norcross, GA (US)

(72) Inventor: Dennis J. Trevor, Clinton, NJ (US)

(73) Assignee: OFS FITEL, LLC, Norcross, GA (US)

(21) Appl. No.: 14/640,531

(22) Filed: Mar. 6, 2015

(51) Int. Cl. C03B 37/014; C03B 37/012

(52) U.S. Cl. CPC C03B 37/01413; C03B 37/01211; C03B 37/01248; C03B 37/01282; C03B 37/0148; C03B 2201/12

(57) ABSTRACT

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica crystals, the disclosed process uses porous silica grains that have a substantially monodisperse size distribution as the starting materials for a powder-in-tube preform manufacturing process and utilize silicon tetrafloride doping to promote silica dehydration.

### CROSS REFERENCE TO RELATED APPLICATIONS

This application incorporates by reference the following U.S. patent applications, which are filed concurrently with this application:

U.S. Patent Application Number [TREVOR 11], having the title “Manufacturing Irregular-Shaped Preforms”;

U.S. Patent Application Number [TREVOR 12], having the title “Using Porous Grains in Powder-in-Tube (PIT) Process”;

U.S. Patent Application Number [TREVOR 10], having the title “Easy Removal of a Thin-Walled Tube in a Powder-in-Tube (PIT) Process.”

### BACKGROUND

1. Field of the Disclosure

The present disclosure relates generally to manufacturing and, more particularly, to manufacturing preforms.

2. Description of Related Art

Optical fiber preforms possess properties that determine the characteristics of optical fibers that are eventually drawn from those preforms. The quality of an optical fiber correlates with the quality of materials that are used in manufacturing the preform from which the optical fiber is drawn. As one can imagine, using higher-quality starting materials results in increased costs. In view of this, there are ongoing efforts to reduce the manufacturing costs of the preforms, and concurrently to improve the quality of the preforms.

### SUMMARY

Disclosed herein are various embodiments of systems and processes that employ porous silica grain in a preform manufacturing process. In some embodiments, the porous silica grains are purified, sintered, and consolidated.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an empty silica tube that has been sealed at the bottom.

FIG. 2 shows a core rod placed within the silica tube of FIG. 1.

FIG. 3 shows the silica tube of FIG. 2 being filled with silica grains.

FIG. 4 shows an enlarged view of the silica grains of FIG. 3.

FIG. 5 shows a mesoporous structure of one of the silica grains of FIG. 4.

FIG. 6 shows a purification process being applied after the silica-grain-filling process of FIG. 3.

FIG. 7 shows a vacuum being applied to the silica-grain-filled tube after the purification process shown in FIG. 6.

FIG. 8 shows sintering and condensation of the silica-grain-filled tube in the presence of the vacuum applied in FIG. 7.

### DETAILED DESCRIPTION OF THE EMBODIMENTS

Currently, optical fibers are designed with very stringent specifications in optical performance, mechanical strength, physical dimensions, and reliability. With increasing demands for bandwidth, these specifications continue to become increasingly stringent. In order for optical fibers to meet such stringent specifications, manufacturers employ exacting controls over the manufacturing process. While strict controls over the process contribute to the fiber quality, another factor that affects the quality of the fiber is the quality of the starting materials that are used to manufacture the optical fiber preforms from which the fibers are drawn. For example, if a preform contains impurities or defects, then those imperfections can result in degraded performance. Specifically, surface contamination and refractory particles, which act as stress centers during the fiber drawing process, affect the mechanical properties of optical fibers and contribute to fiber breakage. As such, much effort is devoted to using high-purity starting materials with minimal contaminants.

In one preform manufacturing process, known as a powder-in-tube (PIT) process, a silica tube is filled with silica powder and consolidated at high temperatures in the presence of a vacuum, thereby resulting in an optical fiber preform. Because conventional PIT processes typically use fully densified silica crystals, any refractory particle that is trapped within those densified crystals becomes a part of the preform. Consequently, those trapped refractory particles degrade the mechanical properties of the optical fiber that is eventually drawn from the preform. Thus, in order produce industrially-acceptable preforms, the conventional PIT processes use ultra-pure silica powder. In other words, because the resulting optical fiber inherits the impurities in the silica powder in conventional PIT processes, those processes strive to use silica of the highest purity as the starting materials. Unfortunately, ultra-pure silica is expensive. Hence, the cost of the resulting fiber is directly traceable to the cost of the silica starting materials.

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica crystals, the disclosed processes use porous silica grains that have a substantially monodisperse size distribution. Stated differently, porous silica grains with substantially uniform grain size are used as the starting materials for the disclosed PIT processes. In one preferred embodiment, 150-micrometer-size porous silica grains are used as the particular starting material. Preferably, the porous silica grains are mesoporous silica grains having a pore size of between approximately two (2) nanometers (nm) and fifty (50) nm. However, it should be appreciated that larger or smaller pore sizes will also work in the disclosed processes and systems.

To the extent that pores in the mesoporous silica grains are connected to the surface of the grains, the connected porosity provides a mechanism that allows impurities that are smaller than the pore size to diffuse to the surface of the silica grain, thereby permitting purification of the mesoporous silica grains. Since the mesoporous structure permits purification, unlike the fully densified silica crystals, the disclosed PIT process is not as restricted to the use of ultra-high-purity silica that is typically required for conventional PIT processes.

The disclosed embodiments permit several processing steps, which are conventionally performed individually, to be performed simultaneously, resulting in cost reductions not are not typically achievable in conventional processes for similar quality optical fiber performs. The mesoporous silica has a higher surface-to-volume ratio than fully densified silica. Thus, the temperature at which the mesoporous silica softens is lower than the temperature at which the silica tube softens. For this reason, the mesoporous silica can be sintered concurrently with the consolidation of the silica tube. Further, dehydration of the mesoporous silica grains may be performed by silicon tetrafluoride (SiF₄) doping. When heated, a dehydration reaction between SiF₄ and silica results in fluorine doping of the silica, and importantly, creates a negative pressure (or vacuum). Other processing steps, sintering and consolidation, are also performed at a similar temperature and require a vacuum. Thus, SiF₄ doping can permit dehydration, sintering, and consolidation to be performed simultaneously. The ability to dehydrate, sinter, and consolidate in a single step further reduces costs because only one high-temperature step is needed to accomplish all three processes. Further, dehydration by SiF₄ doping has the added time and cost benefit of eliminating the need to draw a vacuum using external mechanisms.

As described in greater detail herein, using substantially homogeneous mesoporous silica grains provides a more economical approach to manufacturing optical fiber preform. Having provided an overview of several embodiments, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

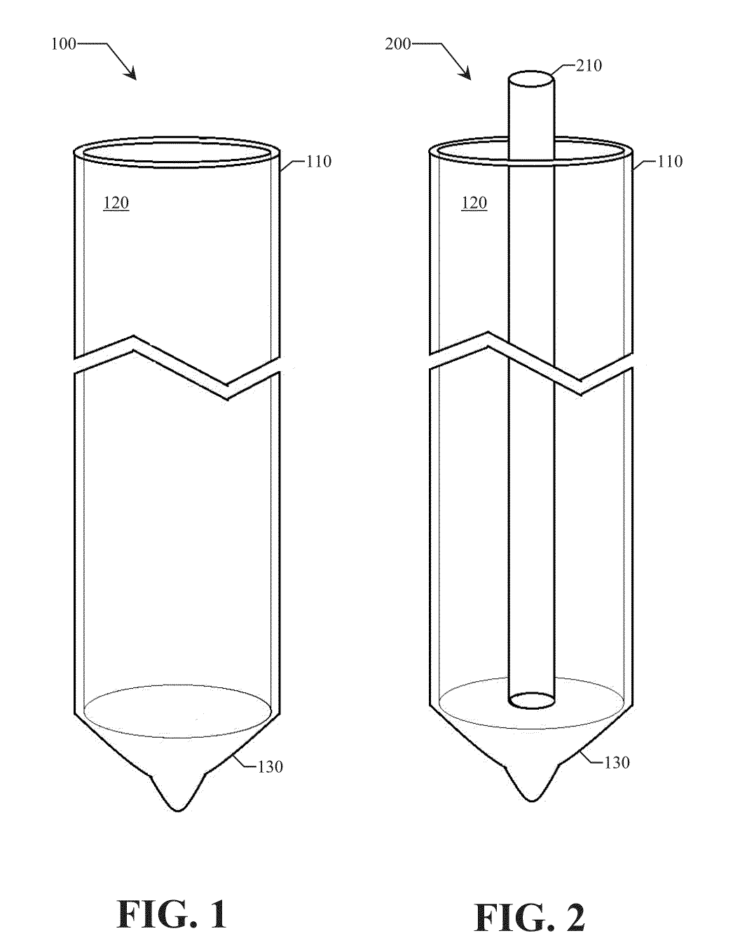

Generally, FIGS. 1 through 8 illustrate several embodiments of the inventive PIT preform-fabrication process, and FIGS. 4 and 5 show the structure of mesoporous silica grains with a substantially monodisperse size distribution (or uniform grain size), which are used as the starting materials for the disclosed PIT processes. Also, with reference to FIGS. 4 and 5, a sol-gel process for manufacturing mesoporous silica having substantially-uniform grain sizes is discussed.

FIG. 1 shows one embodiment of a hollow tube 100 that is used in a powder-in-tube (PIT) preform manufacturing process. As shown in the embodiment of FIG. 1, the hollow tube 100 is a silica tube 110 with a cavity 120 and a sealed bottom 130. This silica tube 110 is preferably fabricated from fused quartz. The quality of the silica tube 110 can vary, depending on whether the glass from the silica tube 110 that eventually becomes a part of the preform will be removed by etching or machining For illustrative purposes, the silica tube 110 described herein is a thin-walled tube that is approximately 1.2 meters (m) in length with a wall thickness of approximately seven (7) millimeters (mm). Experiments have been successfully conducted using thin-walled tubes that have inner diameters that ranged from approximately 35 mm to approximately 90 mm. While these dimensions are provided to more clearly illustrate one embodiment of a PIT process, it should be appreciated that the dimensions of the silica tube 110 may be modified based on the manufacturing tolerances and preferences.

FIG. 2 shows a tube-and-core-rod setup 200, where a core rod 210 is placed within the silica tube 110. Placing the core rod 210 in the silica tube 110, as shown in FIG. 2, permits manufacturing of optical fiber preforms that can be drawn into an optical fiber.

Conversely, a thin-walled silica tube 110 without a core rod, as shown in FIG. 1, can be used in the manufacturing of silica jackets that can be used in, for example, a rod-in-tube process. For illustrative purposes, the PIT processes described herein are implemented using the tube-and-core-rod setup 200. However, it should be appreciated that similar PIT processes can be implemented with the hollow tube 100 in the absence of the core rod.

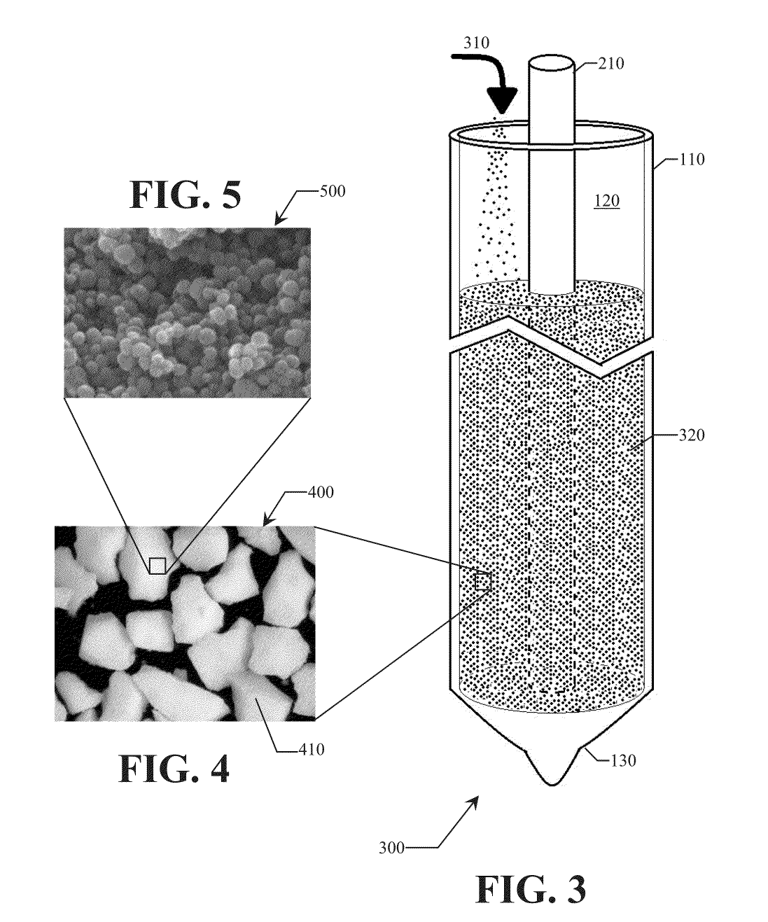

With the starting tubes and configurations of FIGS. 1 and 2 in mind, attention is turned to FIG. 3, which shows a tube-filling setup 300, where the silica tube 110 of FIG. 2 is filled with silica grains 310. As shown in FIG. 3, the thin-walled silica tube 110 has a sealed bottom 130, which permits filling of the cavity 120 from the top of the silica tube 110. Since the embodiment of FIG. 3 includes a core rod 210, entering silica grain 310 from the top opening fills the space in the silica tube 110 surrounding the core rod 210, and the silica grain 320 accumulates from the bottom upward. For some embodiments, a mild mechanical disruption can be introduced during the filling process to permit the settled silica grains 320 to achieve a random-close-packed density. The resulting configuration is random-close-packed silica grains (or powder) 320 in the silica tube 110, and hence the name powder-in-tube (PIT).

Unlike conventional PIT processes that use fused quartz silica grains, the tube-filling setup of FIG. 3 uses mesoporous silica grains 410, which are shown in greater detail in enlarged view 400 of FIG. 4. In one preferred embodiment, the mesoporous silica grains 410 have a substantially monodisperse size distribution, meaning that the mesoporous silica grains 410 have a substantially uniform (or homogeneous) grain size. Since the purification time for the mesoporous silica grains 410 is directly proportional to the diffusion length of the contaminants that are being purged, a larger grain size results in a longer purification time, while a smaller grain size results in a correspondingly-shorter purification time. Also, if faster sintering is desired, then a smaller grain sizes are preferable, since smaller particles sinter faster than larger particles. In one preferred embodiment, approximately-150-micron-size mesoporous silica grains 410 are used as the starting materials for the disclosed PIT processes. However, it should be appreciated that the grain size can be varied as desired, with a preferred grain size being between approximately 25 microns and 250 microns.

It is worthwhile to note that the random-close-packed density is the same irrespective of the grain size, as long as the grains are substantially homogeneous. As such, whether the grains are uniformly 25 microns, 70 microns, 150 microns, or 250 microns, as long as the size distribution is monodisperse, the packing density is substantially the same.

One way of manufacturing the substantially homogeneous mesoporous silica grains 320 is by using a sol-gel process. Since sol-gel processes are well-known in the art, only a truncated discussion of the process is provided herein to properly frame the inventive PIT processes. Within the sol-gel process, fumed silica is dispersed in water using an appropriately-small quantity of tetramethyl ammonium hydroxide. This dispersion is mixed under high-shear conditions and then centrifuged to remove particulates of higher density, typically comprising metals, metal oxides, and large particulates of comparable density, usually of incompletely dispersed silica agglomerates. The mixture is filtered once again, but this time to remove dissolved gases and bubbles. Thereafter, the mixture is aged and dried, which results in a mesoporous silica cake. And, it is from this mesoporous silica cake that the mesoporous silica grains 320 are derived. Specifically, the dried cake is crushed and ground into a desired uniform grain size (e.g., 150-micron-size grains). At this point, the impurities in the dried gel include comparable masses of water and organic species (a few percent by weight of each), a fraction of a percent surface hydroxyl, and parts-per-million (ppm) levels of metals and metal oxides. In other words, at this point, the mesoporous silica grains 320 still have impurities. However, as discussed below, those impurities can be removed during the disclosed PIT process.

A closer examination of the pore structures is helpful in understanding the purification mechanism in the disclosed PIT process. For this reason, FIG. 5 shows a pore structure 500 of one of the mesoporous silica grains 410. As shown in FIG. 5, the pores in the mesoporous silica grains 410 are connected to the surface of the grains. The connected porosity of the pore structure 500 provides a mechanism that allows impurities that are smaller than the pore size to diffuse to the surface of the silica grain. As noted earlier, if the grain size is sufficiently small to permit implementation of diffusion-based purification processes, then the mesoporous silica grains 410 can be purified during the PIT process, thereby ameliorating the need for ultra-pure silica as the starting materials. In other words, since the mesoporous structure permits purification, unlike the fully densified silica crystals in conventional PIT processes, the disclosed mesoporous structure results in a cost reduction when compared to the use of fully densified silica grain.

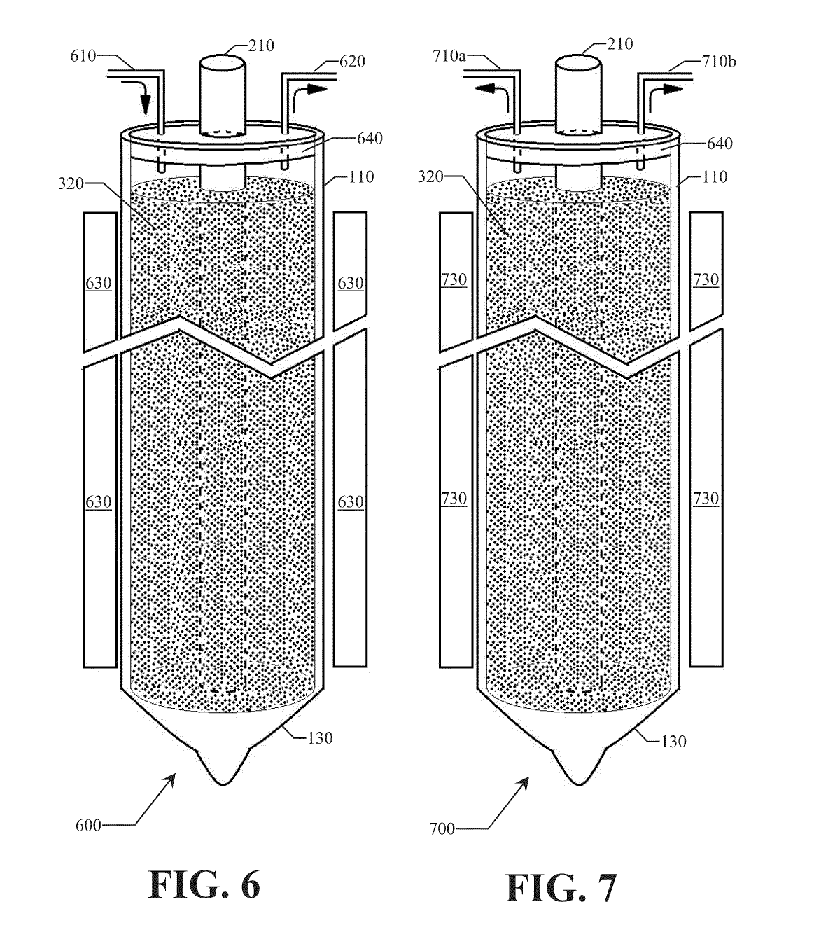

With this in mind, attention is turned to FIG. 6, which shows a purification setup 600 that is used to purify the mesoporous silica grains 320 that have filled the silica tube 110, as shown in FIG. 3. In the configuration of FIG. 6, an upper seal 640 is placed on the thin-walled silica tube 110, which, in conjunction with the sealed bottom 130, creates a closed environment within the silica tube 110. The mesoporous silica grains 320 are held within the closed environment. The upper seal 640 comprises an output vent 620, through which the remaining water, organic species, surface hydroxyl, metals, and metal oxides are expelled from the closed environment. Also provided through the upper seal is an input port 610 through which chlorine, silicon tetrafluoride (SiF₄), nitrogen, thionyl chlorine, and air may be introduced into the closed environment. The purification setup 600 also includes a heating element 630 (e.g., torch or furnace) that is used in the purification process.

Before discussing the purification process, it is worthwhile to note another advantage of using mesoporous silica grains 320 with the input port 610 and output vent 620. Namely, the pore structure 500 permits doping during the PIT process, and the input port 610 provides a mechanism by which dopants, can be introduced to the mesoporous silica grains 320. As one can see, the output vent 620 expels excess dopants and permits regulation of pressure within the closed environment.

The purification process typically occurs in four phases: (1) removal of unbound water; (2) removal of organics; (3) removal of Si-bound water; and (4) removal of metals and metal oxides. Although it is possible to combine all phases in one furnace process, it is preferable to separate the phases into two distinct processing steps to reduce overall complexity.

First, the removal of solvent water, water of hydration in salts, and organics occur together as the temperature of the purification setup 600 is slowly ramped to between approximately 600° C. and approximately 650° C., while concurrently shifting from anaerobic environment to an aerobic environment. Since those compounds are trapped in a mesoporous material 500, the heat causes those impurities to diffuse to the surface of the mesoporous silica grain 410 for eventual evacuation through the output vent. Since 650° C. is well below the melting point of silica, the mesoporous silica material 500 maintains its shape during this evacuation process.

Second, the Si-bound water and removal of metals and metal oxides occurs conventionally by increasing the temperature to between approximately 900 and approximately 950° C. and introducing chlorine and thionyl chloride into the purification setup 600 through the input port 610. The mesoporus silica material 500 used for the jacket in the PIT process has a greater surface area than the mating center core, thus requiring chemical removal of any water that is bound to Si in the form of SiOH, which is not removed by thermal processes. At these temperatures, silica reacts with the chlorine, thereby resulting in the dehydroxylation of the silica and removal the Si-bound water. Metal and metal oxide refractories (such as zirconia and chromia) are removed by reacting with the chlorine and/or thionyl chloride.

Chlorine is most commonly used to remove Si-bound water during the purification process. However, chlorine and most other typical dehydrating agents have a limited solubility (in the range of parts-per-million (ppm)), thus, typically requiring them to be removed from the packed mesoporous silica or “green body.” Solubility of these agents decreases further upon increasing temperature, which is achieved in later steps in the preform manufacturing process. If excess chlorine or other dehydrating agent gas is present, air-lines may be present in the final fiber or other detrimental effects may result, as can be understood by one having ordinary skill in the art. Stated differently, typical dehydrating agents have a low solubility (ppm), which causes any excess dehydrating agent to produce air-lines or other detrimental effects when exposed to higher temperatures achieved during subsequent processing steps.

Therefore, typically, chlorine or other dehydrating agent gas is removed by replacement with helium (He) or by drawing a vacuum. However, removal of the dehydrating agent takes processing time, significant He use, expensive toxic gas delivery systems, or vacuums and scrubbers, which are often difficult to incorporate with other high temperature processes, such as a final fiber draw.

To overcome shortcomings related to the use of chlorine and other conventional dehydrating agents, the embodiments disclosed herein employ SiF₄ gas to remove Si-bound water from the mesoporous silica material 500. In one embodiment after removal of the metals and metal oxides, SiF₄ gas is introduced, and the purification set up is sealed and heated to a temperature greater than approximately 1000° C. In other words, the purification process comprises removal of unbound water and organics, followed by removal of metals and metal oxides, followed by removal of Si-bound water, which is achieved by introducing SiF₄ gas, sealing the purification setup 600, and heating the purification setup 600 to greater than approximately 1000° C.

Removal of Si-bound water occurs via a dehydroxylation reaction according to the following:

SiₛOH→SiₛF+SiF₃OH [Eq. 1]

SiF₄+3SiₛOH→4SiₛF+3/2 H₂O (g)+3/4 O₂(g) [Eq. 2]

SiF₄ will dehydrate the green body similarly to other halogens. However, SiF₄ does not react with silica in the same manner as chlorine based dehydrating agents. Specifically, when heated to a temperature of greater than approximately 1000° C., SiF₄ reacts with silica according to the following reaction:

3SiO₂+SiF₄(g)→4O_{1.5}SiF [Eq. 3]

Accordingly, one having ordinary skill in the art can appreciate that the reaction between SiF₄ and silica does not produce gas phase products.

In operation, SiF₄ gas may be added directly to the mesoporous material 500 within the purification setup 600 through the input port 620. Preferably, the SiF₄ gas is added at approximately 0.5 atmospheres. In a preferred embodiment, solid fluorosilicate may be added to the mesoporous material 500. During the process of raising the heat to greater than approximately 1000° C. the solid fluorosilicate decomposes and releases SiF₄ gas. The SiF₄ gas then reacts with silica according to the aforementioned reactions. For some embodiments, solid fluorosilicate may be added during the sol-gel process. Thus, one having ordinary skill will appreciate that in embodiments using solid fluorosilicate as the source of SiF₄ gas, there is no need introduce SiF₄ gas into the purification setup 600 after removal of metals and metal oxides.

An additional benefit achieved by SiF₄ doping is that fluorine (F) is readily soluble (up to approximately 2% wt). Thus, even at high temperatures, in subsequent or simultaneous processing steps, air-lines or other detrimental effects are not produced, unlike dehydration methods employing chlorine. Further, slight doping of silica with F will decrease the viscosity of the glass and allow for subsequent steps, such as sintering and consolidation, to be performed at a lower temperature. Suffice it to say that, although use of SiF₄ or solid fluorosilicate does not negate the need to remove the reaction byproducts from the green body, it does significantly reduce the amount of reaction byproducts requiring removal.

Importantly, the reaction of SiF₄ with silica creates an ultra dry vacuum when the purification apparatus 600 is sealed and later heated to greater than approximately 1000° C. As the SiF₄ and mesoporous material 500 are heated, the partial pressure created generates a favorable shift in the equilibrium between SiF₄ and silica, thus catalyzing the reaction where F diffuses into the silica. Vacuum generation is facilitated by a slow rate of F diffusion into the silica. As such, there is no need for the use of expensive pumps to draw the vacuum sometimes used for the removal of conventional dehydrating agents.

With these particular advantages in mind, one can appreciate that SiF₄ doping can result in further cost-savings by permitting silica dehydration to be performed simultaneously with subsequent steps in the PIT process, such as sintering and consolidation, which are also performed at high temperatures (up to between approximately 1600° C. and approximately 1750° C.) and in a vacuum. In other words, by using SiF₄, the steps of removal of Si-bound water, sintering, and consolidation, as disclosed herein, may be performed simultaneously. By performing these three steps simultaneously, which in conventional PIT processes are performed individually, significant time, energy, and economic savings can be realized.

Although not preferred, there may be situations where SiF₄ mediated removal of Si-bound water is performed as an individual step. In this case, a separate vacuum must be drawn to facilitate sintering and consolidation. With this in mind attention is directed to FIG. 7, which shows a vacuum application setup 700 in which a vacuum is applied to the silica-grain-filled tube. The input port 620 (FIG. 6) and the output vent 620 (FIG. 6) now serve as vacuum ports 710a , 710b (collectively 710), through which a vacuum is drawn, thereby reducing the pressure within the silica tube 110. Here, the upper seal 640 and the sealed bottom 130 provide a closed environment, thereby allowing for depressurization through the two vacuum ports 710. Since the mesoporous silica has a higher surface-to-volume ratio than fully densified silica, by drawing a vacuum within the silica tube 110, the consolidation temperature of the mesoporous silica grains 320 is lower than the temperature at which the silica tube softens. Thus, by increasing the heating elements 730 to approximately 1735° C. while drawing a vacuum, the mesoporous silica grains 320 can be sintered before the fully densified silica tube 110 reaches its melting point.

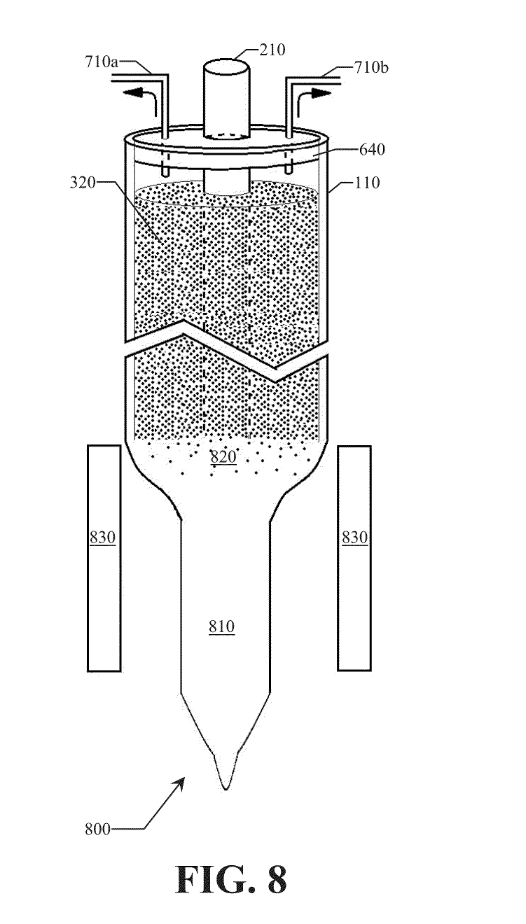

As shown in FIG. 8, given the proper combination of high temperatures and vacuum, the mesoporous silica grains 320 sinters 820 substantially concurrently with the consolidation of the silica tube 110. This results in a high-purity, fully-densified silica body 810. This ability to sinter and consolidate in a single step further reduces costs, because only one high-temperature step is needed to accomplish both sintering and consolidation. Alternatively, in a preferred embodiment, sintering and consolidation is performed simultaneously with SiF₄ mediated dehydration, resulting in further cost-savings over conventional perform manufacturing processes that rely on using ultra-pure silica.

The embodiments disclosed herein seek to ameliorate the high costs associated with the use of ultra-pure silica by using a lower-cost starting material and purifying the lower-cost starting material to an acceptable level of purity during the preform manufacturing process. In one embodiment, instead of using fully densified silica crystals, the disclosed processes use mesoporous silica grains that have a substantially monodisperse size distribution. Stated differently, mesoporous silica grains with substantially uniform grain size are used as the starting materials for the disclosed PIT processes. In one preferred embodiment, 150-micrometer-size mesoporous silica grains are used as the particular starting material.

As described with reference to FIGS. 1 through 8, the use of mesoporous silica grains 320 permits the application of purification processes that cannot be applied to fully densified silica crystals. Thus, the disclosed PIT process is not as restricted to the use of ultra-high-purity silica that is typically required for conventional PIT processes. Consequently, the disclosed PIT process provides a cost reduction that is typically not achievable in conventional processes for similar quality optical fiber preforms. Additionally, the porosity of the mesoporous silica 500 permits doping during the PIT process, concurrent sintering of the mesoporous silica grains 320 with the consolidation of the silica tube 110, and further cost reductions by using a single high-temperature dehydration-sintering-and-consolidation step. Ultimately, the use of mesoporous silica grains 320 as the starting material for the disclosed PIT process no longer requires the manufacturer to use the highest-purity starting materials for preform fabrication but, rather, allows a lower-cost material to be purified to the necessary specifications, thereby reducing a large portion of the manufacturing costs.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. For example, it should be appreciated that the term mesoporous means a porous structure in which the pores are connected to the surface of the grain. All such changes, modifications, and alterations should therefore be seen as within the scope of the disclosure.

1. A powder-in-tube perform manufacturing process, comprising:
sealing a bottom of a thin-walled silica tube;
inserting a core rod into the silica tube, the inserted core rod being substantially centered within the silica tube;
filling the silica tube with mesoporous silica grains, the mesoporous silica grains being substantially monodisperse in size;
removing impurities by heating the mesoporous silica grains to a temperature that is less than approximately 800 degrees Celsius (° C.);
adding silicon tetrafluoride gas (SiF₄) to the purified mesoporous silica grains;
heating the purified mesoporous silica grains in the presence of the SiF₄ gas at a temperature of greater than approximately 1000° C., which results in dehydration of the purified mesoporous silica and fluorine doping of silica;
sintering the purified mesoporous silica grains in the presence of SiF₄; and
consolidating the silica tube.

2. The process of claim 1, wherein heating the mesoporous silica grains in the presence of the SiF₄ gas results in a depressurization of the silica tube.

3. The process of claim 1, the SiF₄ gas being added to the silica tube to create a about 0.5 atmospheres of pressure of SiF₄ gas within the silica tube.

4. A preform manufacturing process, comprising:
filling a silica tube with substantially homogeneous mesoporous silica grains;
purifying the mesoporous silica grains in the presence of silicon tetrafluoride (SiF₄) gas;
sintering the mesoporous silica grains; and
consolidating the silica tube.

5. The process of claim 4, further comprising:
adding solid fluorosilicate to the silica tube prior to purifying the mesoporous silica grains.

6. The process of claim 5, further comprising:
heating the mesoporous silica grains and solid fluorosilicate to convert the solid fluorosilicate into the SiF₄ gas.

7. The process of claim 4, further comprising:
permeating the SiF₄ gas through the mesoporous silica grains prior to purifying the mesoporous silica grains.

8. The process of claim 7, the SiF₄ gas being added to the silica tube to create a about 0.5 atmospheres of pressure of SiF₄ gas within the silica tube.

9. The process of claim 4, the purifying of the mesoporous silica grains in the presence of SiF₄ gas further comprising:
heating the mesoporous silica grains to a temperature greater than approximately 1000° C.

10. The process of claim 9, the heating of the mesoporous silica grains in the presence of SiF₄ resulting in a depressurization of the silica tube.

11. The process of claim 10, the purifying of the mesoporous silica grains being substantially concurrent with sintering of the mesoporous silica grains.

12. A preform manufacturing system, comprising:
mesoporous silica grains;
silicon tetrafluoride (SiF₄) gas;
a silica tube to hold the mesoporous silica grains and the SiF₄ gas;
an input port to introduce gases into the silica tube;
an output vent to evacuate impurities from the silica tube; and
a heating element to heat the mesoporous silica grains.

13. The system of claim 12, further comprising solid fluorosilicate, the silica tube further to hold the solid fluorosilicate, the heating element further to heat the solid fluorosilicate to generate the SiF₄ gas.

14. The system of claim 12, the mesoporous silica grains having a substantially homogeneous grain size of approximately 150 microns.

15. The system of claim 12, the heating element being a furnace.

16. The system of claim 12, the heating element being a torch.

17. The system of claim 12, the silica tube being a thin-walled tube.

18. The system of claim 17, the thin-walled tube having a wall thickness of approximately seven (7) millimeters.
